(19) United States
(12) Patent Application Publication
(10) Pub. No.: US 2016/0376436 A1
(43) Pub. Date: Dec. 29, 2016

(54) MATERIAL COMPOSITION FOR PRODUCING BEER BOTTLE AND METHOD OF PRODUCING BEER BOTTLE

(71) Applicant: BEIJING CHAMGO NANO-TECH CO., LTD., Beijing (CN)

(72) Inventors: Bizhong Li, Beijing (CN); Kun WU, Beijing (CN); Renzhong TAN, Beijing (CN); Huixian CUI, Beijing (CN)

(73) Assignee: BEIJING CHAMGO NANO-TECH CO., LTD., Beijing (CN)

(21) Appl. No.: 15/125,111

(22) PCT Filed: Apr. 30, 2014
(86) PCT No.: PCT/CN2014/076575

§ 371 Date: Sep. 9, 2016

(30) Foreign Application Priority Data
Mar. 12, 2014 (CN) 201410090358.8

(51) Int. Cl. C08L 67/02; B29B 11/08; B29C 49/00; B29C 49/06; B29C 49/64; C08K 5/18; C08K 5/134; C08K 5/00; C08K 5/372; C08K 5/17; C08K 5/524; C08K 5/3465; B29B 7/88; C08K 3/34

(52) U.S. Cl. CPC C08L 67/02; B29B 7/88; B29B 11/08; B29C 49/0005; B29C 49/06; B29C 49/64; C08K 3/346; C08K 5/1345; C08K 5/0091; C08K 5/372; C08K 5/175; C08K 5/524; C08K 5/3465; C08K 5/18; B29K 2067/003

(57) ABSTRACT

A material composition for producing nanometer barrier polyethylene terephthalate (PET) monolayer beer bottles, the composition comprising layered silicate nano-composite PET material, antioxidant, colorant, dispersant and the like, and also relates to a method of producing beer bottles. The monolayer PET bottles have good barrier property, low oxygen penetration, good light blocking property, and can extend the service life of PET bottled beer; the bottles have good thermal resistance, and meet requirements of beer bottling and pasteurization (for 30 min at 60° C.); the bottles are light weight, do not burst, and meet requirements of transport, storage and consumption.

This application is the U.S. national phase of International Application No. PCT/CN2014/076575 Filed on 30 Apr. 2014 which designated the U.S. and claims priority to Chinese Application Nos. CN201410090358.8 filed on 12 Mar. 2014, the entire contents of each of which are hereby incorporated by reference.

### FIELD OF THE INVENTION

The present invention belongs to the field of food packaging technology. More particularly, the present invention relates to a material composition for producing polyethylene terephthalate (PET) monolayer beer bottles with nanometer-scaled barrier property, also to the method for producing the beer bottles.

### BACKGROUND OF THE INVENTION

The United States and China are the largest producers and consumers of beer in the world. Currently, the beer packaging containers are mainly made of glass, aluminum and other materials. Over the past decade, in the development of packaging containers for beer, plastic has been valued and also used.

Glass beer bottles have potential safety risks. Thousands of explosive bottle wounding accidents occur each year in China, which not only threatens the safety of consumers, but also caused substantial compensation and moral responsibility to the beer business. In addition, beer bottles should not be used in some circumstances like sports venues, beaches or party outdoors, with their debris being dangerous and easy to hurt people. Cans in metal aluminum and bottles in plastic can avoid glass bottles burst wounding. However, the aluminum cans are of high cost, while plastic bottles have bad performance, especially in poor oxygen barrier; at present, they account for very small market share.

Beer is easy to oxidize and a very small amount of oxygen into it will lead it to taste worse. As beer containers, aluminum cans have the best barrier performance. Except for the sealing of the bottle cap gasket, glass bottles have good sealing performance. Bottles of plastic PET (polyethylene terephthalate, English abbreviation “PET”) have been widely used in Coke, drinking water and other packaging, but they are not ideal for packaging beer. The shelf life for beer in ordinary PET bottles is generally less than 30 days, which seems to be too short in the beer consumer market, therefore, the application of PET bottles has been great limited.

Nevertheless, once the weakness of short shelf life for PET beer bottles is overcome, their many advantages as beer packaging containers will reveal. The plastic bottles have lighter weight than glass bottles, only about 5-14% weight of the glass ones, which can save a lot of transportation costs, thus expand the sales scope of beer. They are easy to carry when consumed. The plastic bottles have good impact resistance and are not easy to break, and will not break when collide with each other or fall from the vehicle after filled with beer, which can reduce the loss of beer during storage and transportation. The plastic bottles have good pressure resistance and are not easy to explode. Under the pressure of bottled beer, the explosion probability is close to zero, which can ensure the safety of human life. They have free switch and are convenient to intermittent drinking as other soft drinks.

The PET beer bottles must have the following comprehensive performances to meet the requirement for being beer packaging. First, due to high sensitivity of beer to oxygen and light, PET bottles are required to have extremely low oxygen permeation to ensure adequate shelf life. Second, low carbon dioxide permeation is required to prevent the loss of carbon dioxide leaking out of the bottle, to maintain the taste of beer. Third, PET bottles must have heat-resistance to withstand temperature of sterilization (at 60° C. for 30 min) and will not deform. Forth, PET bottles have sufficient rigidity to withstand the filling operation and laminate stacking. Fifth, PET bottles are not toxic and may not contain harmful substances on the human body. Sixth, they are easy to recycle and do not cause environmental pollution.

At present, some patents or patent applications involving plastic bottles for beer are aimed at non-explosive bottles, heat-resistance, durable performance and other properties. For example, Chinese Patent Application No. 1229045A discloses a plastic bottle for beer made of PEN or PETP. Chinese Patent Application Nos. 1406837A and 101357823A disclose nano bottles for beer and their preparations, which consist in SiO₂ nanoparticles being melted in glass or plastic to be manufactured into explosion-proof material, and then made into explosion-proof glass bottles or plastic bottles for beer. Chinese Patent Application No. 1267624A discloses a method in which adding 0.5% silicone material into PET material to form a polyester soft bottle for beer.

Chinese Patent Application No. 1323845A discloses a preparation method for beer bottle material containing PEN (polyethylene naphthalate) and PET. The beer bottles made from the material has good heat-resistance and superior dimensional stability and hydrolytic stability over ordinary PET beer bottles. U.S. Pat. No. 3,971,173 discloses an approach for heat setting PET container to increase its heat stability.

Some of utility models disclose improvements in the shape and the structure of the beer bottle to enhance the heat resistance of the beer bottle and the anti-deformation ability of the bottle bottom. For example, such utility models are CN 2570208Y, CN 2484280Y, CN 2764735Y and CN2575046Y, as well as U.S. Pat. No. 3,971,173A, US 2002088767A1 and US 2007045220A1.

Aiming at the shortcomings of PET beer bottle's inadequate barrier property, so far the research and development of technology can be roughly divided into three types.

The first type is the barrier coating technology in which the barrier coating are used on the inner or outer walls of PET bottles, such as a new Actis bottle equipment developed by Sidel Machinery Manufacturing Co., France. By using the equipment, microwave processor will intensify acetylene and transfer it into plasma and form a thin and dense coating of highly oxidized amorphous carbon in solid state (refer to food business network, http://www.21 food.cn, Apr. 4, 2005).

The second type is a multilayer barrier technology and PET bottles with a structure of multiple barrier layers. For example, Kortec Co. Ltd., U.S. manufactured a co-injection plastic system (“World Plastics”, 2005, 23(10): P38). Husky Co., a Canadian injection molding machine and mold manufacturer, developed a PET multilayer bottle, which was based on the barrier layer of polyvinyl alcohol (EVOH). In the PET multilayer bottle, the inner and outer layers are PET and the middle layer is EVOH, through SurBond-E barrier material adhesive, PET and EVOH are bonded together (http://www.plasticstoday.com, Jun. 30, 2007). Chinese Utility Model Patent Application No. 2513945Y relates to a multi-layer polyester beer bottle, the material of the inner layer and outer layer of which is polyester, there is a layer of oxygen barrier material between two layers to increase the barrier effect of beer bottles. Chinese Patent Application No. 101360601A discloses a multilayer bottle in which polyamide is used as barrier layer in the middle of two layers of PET.

The third type is other barrier technologies, such as three-layer bottles containing the deoxidizer, and multi-layer PET bottles containing nylon oxygen-adsorbing layer. (“Materials World”, 2000,8(8), P14; “World Plastics”, 2005, 23 (10), P38).

Coating technology and multilayer technology has such characters as complex technology, expensive equipment and high cost of material. As a result, the beer bottles obtained by coating and multilayer technology have high cost. In addition, there are difficulties in controlling the quality of coating bottle's coating and the recycling and utilization of multilayer bottles.

Development of monolayer PET beer bottles does not need special equipment and has low processing costs. Its key is to improve the barrier properties of PET raw materials, in order to obtain a satisfactory shelf life of beer. PET resin production enterprises, such as Invista, Eastman, M & G Chemicals, Novapet Co. and the like of the United States, have carried out the development of PET resin with barrier property. But the PET blends use EVOH, nylon and other components as barrier material, which will have a negative impact on the waste recycling (http://www.plasticstoday.com, Jun. 30, 2007).

Whether single PET bottles or multilayer ones, their oxygen barrier properties can be improved by adding deoxidant. For example, Canadian Patent Application No. CA2266634 discloses an addition of polyester-based oxygen scavenger copolyester in the intermediate layer in a three-layer bottle, thus obtained PET bottle has oxygen permeation rate close to zero. US Colormatrix companies use this deoxidant to produce granular masterbatch for market, making PET molding process becomes more easy. The PET bottles made from the deoxidant masterbatch Amosorb can eliminate and capture oxygen contained in PET and that penetrated in from the outside of bottles, which can improve the shelves cycle of drinks such as fruit juices, beer, wine and tea drinks which are oxygen-sensitive. Valspar Co., US has developed a range of thermoplastic oxygen scavenging material Valor (“World Plastics”, 2005, 23(10): P38). However, the said deoxidant and PET adding the deoxidant once exposed to air, it will react with oxygen and fail. Therefore, the deoxidant, the deoxidant masterbatch and the bottle preforms and bottles containing the deoxidant and other products must be manufactured and stored under strict anaerobic condition. The PET bottle preforms and bottles containing deoxidant need to be used in short-term, otherwise the failure of deoxidant will make them have not good oxygen barrier properties. In addition, the production of PET bottle using the deoxidant will also have a high production cost.

Selection of suitable nanocomposite with barrier property is the key to manufacturing PET bottle having a good barrier property. Chinese Patent Application No. 1500702A discloses a saturated polyester adding nanoscale SiO₂ particles in its synthesis. Compared with the conventional saturated polyester, it has excellent heat resistance and high air impermeability, and can be used as containers for fruit drinks, beer, tea and rice beverage. But the geometry feature of the nanoscale SiO₂ particles determines that they are not very good barrier material.

Mitsubishi Gas Chemical Company, in partnership with Nanocor International Ltd, U.S., has developed multilayer PET bottles using blend of Imperm nanoclay/MDX6 nylon as a barrier layer (“World Plastics”, 2005, 23(10), P38).

In addition, Chinese Patent Application No. 1586995A discloses a plastic beer bottle, in which there is an inner bag made of barrier material. The inner bag is fit into the plastic beer bottle to achieve high temperature resistance and high barrier effect. This production technology is complex and has the low operability.

In summary, in order to make PET beer bottles meet the utility requirement, some researchers have done a lot of work to improve the heat resistance, strength and anti-crack performance, especially to improve the barrier properties. However, the prior art is complicated and costly, or has not ideal heat resistance and barrier and cannot be widely used. Therefore, in the industrial application, there is an urgent need for PET beer bottles which have performances meeting the requirements of beer bottle packaging, low cost, and their material recycling meets the environmental protection requirements.

### DETAILED DESCRIPTION OF THE INVENTION

### Technical Question to be Solved

One object of the present invention is to provide a material composition for producing polyethylene terephthalate (English abbreviation “PET”) monolayer beer bottles with nanometer-scaled barrier property.

Another object of the present invention is to provide a method for producing the said monolayer beer bottles.

### Technical Plan

The present invention is achieved by the following technical plan.

The present invention relates to a material composition for producing nano-PET monolayer beer bottles with barrier property. The material composition contains the following components in parts by weight:

| | |
|---|---|
| layered silicate PET nanocomposite material | 93.0-99.8; |
| antioxidant | 0.02-2.0; |
| colorant | 0.0-2.0; |
| dispersant | 0.0-3.0. |

According to a preferred embodiment of the present invention, the material composition contains the following components in parts by weight:

| | |
|---|---|
| layered silicate PET nanocomposite material | 95.0-97.0; |
| antioxidant | 0.18-1.56; |
| colorant | 0.04-1.66; |
| dispersant | 0.01-2.45. |

According to another preferred embodiment of the present invention, the said layered silicate PET nanocomposite material is composed of 80-99.7 parts by weight of polyethylene terephthalate, 0.3-10 parts by weight of layered silicate, 0.1-10 parts by weight of intercalation agent and 0.3-10 parts by weight of compatilizer;

The said layered silicate is selected from montmorillonite, hectorite, kaolin natural silicates or magnesium silicate lithium synthetic laminated silicate;

The said intercalation agent is selected from dodecylamine, hexadecylamine, hexylenediamine, lauric acid amine, triethanolamine, dodecyl trimethyl ammonium bromide, cetyl trimethyl ammonium bromide, octadecyl trimethyl ammonium bromide or octadecyl dimethyl benzyl ammonium bromide;

The said compatilizer is selected from ethylene-methacrylic acid copolymer sodium salt, ethylene-methacrylic acid copolymer zinc salt, polyethylene oxide, polypropylene oxide, ethylene oxide-propylene oxide copolymer or bisphenol A epoxy resin.

According to another preferred embodiment of the present invention, the said antioxidant is one or more antioxidant(s) selected from hindered phenolic antioxidants, thioester antioxidants or phosphite antioxidants;

The said hindered phenolic antioxidant is selected from tetra-[β-(3,5-di-tert-butyl-4-hydroxyphenyl)propionate]pentaerythritol ester, n-octadecyl β-(3,5-di-tert-butyl-4-hydroxyphenyl)propionate, N,N′-bis[3-(3,5-di-tert-butyl-4-hydroxyphenyl)propionyl]hexamethylene diamine, Triethylene glycol-bis[β-(3-tert-butyl-4-hydroxy-5-methylphenyl)propionate], N,N′-bis[β-(3,5-di-tert-butyl-4-hydroxyphenyl)propionyl]hydrazine or 4,4′-thiobis(6-tert-butyl-3-methylphenol);

The said thioester antioxidant is selected from dilauryl thiodipropionate, dimyristyl thiodipropionate or distearyl thiodipropionate;

The said phosphite antioxidant is selected from the tri-octanol phosphite, tri-decanol phosphite, tris(dodecanol) phosphite, tris(hexadecanol) phosphite, triphenyl phosphite, tris(2,4-di-t-butylphenyl)phosphite, tetrakis(2,4-di-tert-octaalkoxy)-4,4′-biphenyl diphosphite, bis(2,4-di-t-butylphenyl)pentaerythritol diphosphite, (2,4,6-tri-tert-butyl-phenyl-2-butyl-2-ethyl)-1,3-propanediol phosphite, bis(2,4-di-p-isopropylphenyl)pentaerythritol bisphosphite, 2,2′-ethylenebis(4,6-di-tert-butyl-phenyl)fluorophosphite, tetrakis(2,4-di-t-butylphenyl)-4,4′-biphenyl biphosphite or Spiro-glycol bis[2,2′-methylenebis (4,6-di-tert-butyl phenyl)]phosphite.

According to another preferred embodiment of the present invention, the said colorant is a pigment or a dye;

Wherein the said pigment is selected from Pigment Green 36, Pigment Yellow 68, Direct Blue 199, Pigment Yellow 147, Pigment Green 36, Pigment Orange 61, Pigment Red 178, Pigment Yellow 74, Pigment Yellow 65, Pigment Yellow 151 or transparent yellow iron oxide;

The said dye is selected from Solvent Blue 97, Solvent Violet 36, Solvent Red 179, CAS No. 4174-09-8, CAS No. 247089-62-9, CAS No. 75641-02-0, Solvent Yellow 160:1, Disperse Yellow 241, Solvent Yellow 114, Solvent Orange 60, Solvent Red 111, Solvent Red 135, Solvent Blue 104, Solvent Green 3, Solvent Violet 13 and Solvent Yellow 93.

According to another preferred embodiment of the present invention, the said dispersant is one or more dispersant(s) selected from silicone oils, paraffin oil, poly(ethylene oxide), poly(propylene oxide) or ethylene oxide-propylene oxide copolymer.

According to another preferred embodiment of the present invention, the material comprises one or more additive(s) selected from: (i) polyester, polyolefin or phenoxy resin mixed modifier; (ii) glass fiber or carbon fiber reinforcement; (iii) glass flakes, talc or mica flaky inorganic filler; (iv) polyester-polyether elastomer impact modifiers; (v) sodium benzoate or sodium salts or zinc salts of ethylene-methacrylic acid copolymer nucleating agent; (vi) lubricants sodium salts or zinc salts of aliphatic amides or aliphatic acids with carbon atoms of 16-50; (vii) benzotriazole UV absorber; (viii) polysiloxane mold release agent or (ix) deoxidizer composed of butadiene oligomer or MXD6 oxygen absorbent component and cobalt-containing metal compound catalyst.

The present invention also relates to the method for producing the nano-PET monolayer beer bottles with barrier property from the material composition. The steps of the method are as follows:

A. Production of Beer Bottle Preforms

Drying the layered silicate PET nanocomposite pellets in a dehumidifying dryer at a temperature of 150-170° C. for 4-6 h, then uniformly mixing 93.0-99.8 parts by weight of the dried layered silicate PET nanocomposite pellets and 0.02-2.0 parts by weight of antioxidant, 0.0-2.0 parts by weight of colorant and 0.0-3.0 parts by weight of dispersant, and sending to the inlet of the injection molding machine, melt mixing and plasticizing by the screw in injection molding machine, the resulting fused material injecting into the mold and then injection molding, thereby obtaining the PET monolayer beer bottle preforms;

B. Production of Beer Bottles

Placing the PET monolayer beer bottle preforms on the PET bottle blowing machine, after heating, stretching, blow molding, cooling and mold unloading, obtaining the said nano-PET monolayer beer bottles with barrier property.

According to a preferred embodiment of the present invention, the steps of the method for producing the said nano-PET monolayer beer bottles with barrier property are as follows:

Adding the said colorant and the said dispersant in the preparation of the said layered silicate PET nanocomposite material, then drying the resulting mixture at a temperature of 150-170° C. for 4-6 h, subsequently adding the said antioxidant, mixing and then sending to the inlet of the injection molding machine, melt mixing and plasticizing by the screw in injection molding machine, the resulting fused material injecting into the mold and then injection molding, thereby obtaining the PET monolayer beer bottle preforms.

According to another preferred embodiment of the present invention, the water content of the said layered silicate PET nanocomposite pellets or the said mixture after drying is less than 50 ppm by the weight.

The present invention will be described in more detail below.

The present invention relates to a material composition for producing nano-PET monolayer beer bottles with barrier property. The material composition contains the following components in parts by weight:

| | |
|---|---|
| layered silicate PET nanocomposite material | 93.0-99.8; |
| antioxidant | 0.02-2.0; |
| colorant | 0.0-2.0; |
| dispersant | 0.0-3.0. |

In the present invention, the said layered silicate PET nanocomposite material is the product produced according to the method described in Chinese Patent No. ZL 02123499.X of the applicant.

The said layered silicate PET nanocomposite material is composed of 80-99.7 parts by weight of PET, 0.3-10 parts by weight of layered silicate, 0.1-10 parts by weight of intercalation agent and 0.3-10 parts by weight of compatilizer.

According to the method for producing the layered silicate PET nanocomposite material described in the above-mentioned patent, the intercalation agent is inserted between the lamellae of the said layered silicate, and then melt blended with a compatibilizer and PET resin, resulting in the layered silicate's laminate peeling off. The stripped sheets disperse in the PET matrix in a dispersed state with a thickness of 1-100 nm, and the layered silicate PET nanocomposite material is obtained.

According to GB17931-2003 “poly(ethylene terephthalate) (PET) resin for bottles”, at the temperature of 30° C., phenol and tetrachloroethane mixed solvent by weight ratio of 6/4 is used to measure the intrinsic viscosity of the said layered silicate PET nanocomposite material, which is 0.55-0.78 dl/g.

The said layered silicate is montmorillonite, hectorite, kaolin natural silicates or magnesium silicate lithium synthetic laminated silicate.

The layered silicates used in the present invention are currently commercially available in the market, such as the high-purity inorganic montmorillonite products sold by Nanocor, US under the trade name PGN, PGV and PGW.

The said intercalation agent is selected from dodecylamine, hexadecylamine, hexylenediamine, lauric acid amine, triethanolamine, dodecyl trimethyl ammonium bromide, cetyl trimethyl ammonium bromide, octadecyl trimethyl ammonium bromide or octadecyl dimethyl benzyl ammonium bromide.

The intercalation agents used in the present invention are currently commercially available in the market, such as dodecylamine sold by Jiangsu Feixiang Chemical Co., Ltd., octadecyl dimethyl benzyl ammonium bromide sold by Kailida Chemical Co., Ltd., Yixing City, and cetyl trimethyl ammonium bromide sold by Jinshan Jingwei Chemical Co., Ltd., Shanghai.

The said compatilizer is selected from ethylene-methacrylic acid copolymer sodium salt, ethylene-methacrylic acid copolymer zinc salt, polyethylene oxide, polypropylene oxide, ethylene oxide-propylene oxide copolymer or bisphenol A epoxy resin.

The compatilizers used in the present invention are currently commercially available in the market, such as ethylene-methacrylic acid copolymer sodium salt sold by DuPont Co. under the trade name Surlyn, and ethylene oxide-propylene oxide copolymer sold by Hengdailao Biological Co., Ltd., Shanghai.

In the present invention, the nanoscale layered silicate dispersed in PET has a diameter-thick ratio of tens to thousands. The nanoscale layer has excellent gas barrier properties, especially after the mosaic type arrangement is formed in the lamellar orientation. The Composite PET has excellent barrier properties for all kinds of gas, so that the barrier property of PET material is significantly improved.

The mechanical strength and the resistance to internal pressure of the nano-PET monolayer beer bottle with barrier property depend on the molecular weight of PET. When other conditions were determined, the molecular weight of PET had a positive relationship with the intrinsic viscosity. The greater the molecular weight of PET, the higher its intrinsic viscosity. Bottles made of PET having high intrinsic viscosity will have high mechanical strength, high resistance to internal pressure and high top pressure intensity.

Degradation of PET molecular chain occurred in the process causes molecular weight lower and intrinsic viscosity values decrease. The biggest factor affecting PET degradation is trace moisture contained in PET and its residence time at high temperatures. In order to make PET bottles having high strength, it's key to dry PET material before the molding of PET preforms. In the present invention, a dehumidifying dryer is used to treat layered silicate PET nanocomposite to make composite PET'S moisture content to less than 50 ppm, preferably less than 30 ppm.

When bottle preforms are molded, in the dual role of the melting temperature and mechanical shear plasticizing, PET is oxidized to form polymer radicals and hydrogen peroxide, resulting in PET molecular chain degradation and poor product performance. In the process of stretch blow molding of bottles, when PET bottle preforms deform by heating and stretching at high speed, the molecular chain will be oxidative degradation.

In order to prevent the decrease in molecular weight of PET, the present invention adds antioxidant in the nano-PET bottle components. The said antioxidant is a hindered phenolic antioxidant, thioester antioxidant or phosphite antioxidant, and mixtures thereof.

Hindered phenolic antioxidant can eliminate free radicals of PET molecule, i.e. capture radicals R and R00 formed in the chain reaction stage, so that they will not cause destructive chain reaction. Thioester antioxidants and phosphite antioxidant may decompose hydroperoxides, i.e. antioxidants are capable of inhibiting and delaying generation of free radicals in the initiation process. Hindered phenolic antioxidants belong to primary antioxidants. Thioester antioxidants and phosphite antioxidants belong to auxiliary antioxidant, often used with the primary antioxidants.

According to the present invention, the said hindered phenolic antioxidant is selected from tetra-[β-(3,5-di-tert-butyl-4-hydroxyphenyl)propionate]pentaerythritol ester, n-octadecyl β-(3,5-di-tert-butyl-4-hydroxyphenyl)propionate, N,N′-bis[3-(3,5-di-tert-butyl-4-hydroxyphenyl)propionyl]hexamethylene diamine, triethylene glycol-bis[β-(3-tert-butyl-4-hydroxy-5-methylphenyl)propionate], N,N′-bis[β-(3,5-di-tert-butyl-4-hydroxyphenyl)propionyl]hydrazine or 4,4′-thiobis(6-tert-butyl-3-methylphenol)(i.e. Antioxidant 300).

In the present invention, the hindered phenolic antioxidants are currently commercially available, such as tetra-[β-(3,5-di-tert-butyl-4-hydroxyphenyl)propionate]pentaerythritol ester sold by BASF, Germany under the trade name IRGANOX1010 (formerly Ciba Corporation), N,N′-bis[3-(3,5-di-tert-butyl-4-hydroxyphenyl)propionyl]hexamethylene diamine sold by BASF, Germany under the trade name IRGANOX 1098 (formerly Ciba Corporation), N,N′-bis[β-(3,5-di-tert-butyl-4-hydroxyphenyl)propionyl]hydrazine sold by BASF, Germany under the trade name Irganox MD1024 (formerly Ciba Corporation).

According to the present invention, the said thioester antioxidant is selected from dilauryl thiodipropionate, dimyristyl thiodipropionate or distearyl thiodipropionate.

The thioester antioxidants used in the present invention are currently commercially available in the market, such as dilauryl thiodipropionate sold by Xinglong Chemical Co., Ltd., Beijing under the trade name DLTP, and distearyl thiodipropionate sold by Xinglong Chemical Co., Ltd., Beijing under the trade name DSTP.

According to the present invention, the said phosphite antioxidant is selected from the tri-octanol phosphite, tri-decanol phosphite, tris(dodecanol) phosphite, tris(hexadecanol) phosphite, triphenyl phosphite, tris(2,4-di-t-butylphenyl)phosphite, tetrakis(2,4-di-tert-octaalkoxy)-4,4′-biphenyl diphosphite, bis(2,4-di-t-butylphenyl)pentaerythritol diphosphite, (2,4,6-tri-tert-butyl-phenyl-2-butyl-2-ethyl)-1,3-propanediol phosphite, bis(2,4-di-p-isopropylphenyl)pentaerythritol bisphosphite, 2,2′-ethylenebis(4,6-di-tert-butyl-phenyl)fluorophosphite, tetrakis(2,4-di-t-butylphenyl)-4,4′-biphenyl biphosphite or Spiro-glycol bis[2,2′-methylenebis (4,6-di-tert-butyl phenyl)]phosphite.

The phosphite antioxidants used in the present invention are currently commercially available in the market, such as tri-octanol phosphite (CAS No. 25103-12-2) sold by Huanyu Century Chemical Technology Co., Ltd., Beijing, bis(2,4-di-t-butylphenyl)pentaerythritol diphosphite sold by Qianfeng Chemical Technology Co., Ltd., Wuxi City under the trade name Antioxidant 626, and tetrakis(2,4-di-t-butylphenyl)-4,4′-biphenyl biphosphite sold by BASF under the trade name Irgafos P-EPQ.

According to the present invention, the layered silicate PET nanocomposite material is 93.0-99.8 parts by weight, if the amount of the said antioxidant is less than 0.02 part by weight, the role to preventing PET from degrading played by the antioxidant in the formulation will be poor, the intrinsic viscosity of PET obtained will be relatively low, and the mechanical properties of beer bottles will be poor. If the amount of the said antioxidant is greater than 2.0 parts by weight, then further increase of the amount of antioxidants in the formulation will not improve the role to preventing PET from degrading and decreasing the intrinsic viscosity, while the cost will increase. Thus, when the layered silicate PET nanocomposite material is 93.0-99.8 parts by weight, the amount of the said antioxidant of 0.02-2.0 parts by weight is suitable, preferably 0.18-1.56 parts by weight, more preferably 0.42-0.88 parts by weight.

Furthermore, the light irradiation may also accelerate oxidative deterioration of beer in the process of storage and transportation. After colored, beer bottles can block sunlight and UV penetration, slowing the oxidation of beer and making beer having a longer shelf life. At the same time, colored beer bottles have more appearance changes and richer colors, can be more flexible to adapt to the aesthetic needs of various consumer groups. Traditional colors of glass beer bottles are green and brown. The layered silicate itself has a good performance of barrier to visible light and ultraviolet light.

For the nano-PET monolayer beer bottles with barrier property of the present invention, colored beer bottles could be obtained by coloring the layered silicate nanocomposite material. The said colorant is a pigment or dye.

The said pigment is selected from Pigment Green 36([9H,31H-phthalocyanine(2-)N29,N30,N31,N32]-copper bromide chloride, CAS No. 68512-13-0), Pigment Yellow 68([1,3-dihydro-5,6-bis[[(2-hydroxy-1-naphthyl)methylene]amino]-2H-benzimidazol-2-one(2-)-N5,N6,O5,O6]-(SP-4-2)nickel, CAS No. 42844-93-9), Direct Blue 199 ([29H,31H-phthalocyanine(2-)N29,N30,N31,N32]copper, CAS No. 90295-11-7), Pigment Yellow147 (1,1′-[(6-phenyl-1,3,5-triazine-2,4-diyl)diimino]dianthraquinone, CAS No. 4118-16-5), Pigment Green 36 (1,3,8,16,18,24-hexabromo-2,4,9,10,11,15,17,22,23,25-decachloro-29H,31H-phthalocyanine(2-)N29,N30,N31,N32]-(SP-4-2)-Cyanine K-1360, CAS No. 14302-13-7), Pigment Orange 61 (the reaction product of methyl 2,3,4,5-tetrachloro-6-cyano-benzoate and 4-[(4-aminophenyl)azo]-3-methylaniline and sodium methoxide, CAS No. 106276-78-2), Pigment Red 178 (2,9-bis[4-(phenylazo)phenyl]anthracene [2,1,9-def:6,5,10-d′e′f′]diisoquinoline-1,3,8,10(2H,9H)-tetraone], CAS No. 3049-71-6), Pigment Yellow 74 (2-[(2-methoxy-4-nitrophenyl)azo]-N-(2-methoxyphenyl)-3-oxo-butyramide, CAS No. 6358-31-2), Pigment Yellow 65 (2-[(4-methoxy-2-nitrophenyl)azo]-N-(2-methoxyphenyl)-3-oxo-butyramide, CAS No. 6528-34-3), Pigment Yellow 151 (2-[[1-[[(2,3-dihydro-2-oxo-1H-benzimidazol-5-yl)amino]formyl]-2-oxopropyl]azo]benzoic acid, CAS No. 31837-42-0) or a transparent yellow iron oxide (Pigment Yellow 042, CAS No. 51274-00-1) and the like.

The colorant used in the present invention may be two or more kinds of pigments or dyes or mixtures thereof. Pigments used in the present invention are currently commercially available on the market, such as Pigment Yellow 147 sold by Yuandong Chemical Co., Ltd., Yancheng, or Pigment Red 178 sold by Decaithe Paint Chemical Co., Ltd., Jiangsu Province.

The said dye is Solvent Blue 97 (1,4-bis[(2,6-diethyl-4-methylphenyl)amino]-9,10-anthranone, CAS No. 32724-62-2; 61969-44-6), Solvent Violet 36 (1,4-bis[(2-ethyl-6-methylphenyl)amino]anthraquinone, CAS No. 82-16-6), Solvent Red 179 (14H-benzo[4,5]isoquinolino[2,1-A]perimidine-14-one, CAS No. 6829-22-7), 2,4-dihydro-4-[(5-hydroxy-3-methyl-1-phenyl-1H-pyrazol-4-yl)methylene]-5-methyl-2-phenyl-3H-pyrazol-3-one (CAS No. 4174-09-8), 2,5-dihydro-3,6-di(octadecyl thiophenyl)pyrrolo[3,4-c]pyrrole-1,4-dioneH9Cl) (CAS No. 247089-62-9), 2-[(1,3-dihydro-1,3-dihydro-1,3-dioxo-2H-isoindol-yl)methyl]5,12-dihydroquinolino[2,3-B]acridine-7,14-dione (CAS No. 75641-02-0), Solvent Yellow 160:1 (3-(5-chloro-2-benzoxazolyl)-7-(diethylamino)-2H-1-benzopyran-2-one, CAS No. 35773-43-4), Disperse Yellow 241 (5-[(3,4-dichlorophenyl)azo]-1,2-dihydro-6-hydroxy-1,4-dimethyl-2-oxo-3-cyanopyridine, CAS No. 83249-52-9), Solvent Yellow 114 (2-(3-hydroxy-2-quinolinyl)indan-1,3-dione, CAS No. 7576-65-0), Solvent Orange 60 (CAS No. 6925-69-5), Solvent Red 111 (1-(methylamino)anthraquinone, CAS No. 82-38-2), Solvent Red 135 (CAS No. 20749-68-2), Solvent Blue 104 (1,4-bis[(2,4,6-trimethylphenyl)amino]-9,10-anthracenedione, CAS No. 116-75-6), Solvent Green 3 (1,4-di-p-tolueneamino-anthraquinone, CAS No. 128-80-3), Solvent Violet 13 (CAS No. 81-48-1), Solvent Yellow 93 (CAS No. 4702-90-3) and the like.

Dyes used in the present invention are currently commercially available on the market, such as Solvent Blue 97 sold by Xinxinyuanwang Color Technology Co., Shenzhen, CAS No. 75641-02-0 sold by Pengteng Fine Chemicals Co., Shanghai under the trade name2-[(1,3-dihydro-1,3-dihydro-1,3-dioxo-2H-isoindolyl)methyl]5,12-dihydroquinolino[2,3-B]acridine-7,14-dione, Solvent Red 135 sold by LANXESS Co., Germany, and Solvent Violet 13 sold by Xinghua Chemical Co., Yancheng City.

The said colorant may be a powder, sand, liquid colorants (color oil), masterbatch and other forms of pre-treatment products.

Because materials for producing the nano-PET monolayer beer bottles with barrier property include a variety of components, such as PET, layered silicates, colorants, antioxidants and others, these components should be uniformly dispersed in the PET binder. To make these ingredients more uniformly dispersed in the PET, it is necessary to add a small amount of dispersant in the said material composition. For example, when the amount of layered silicate PET nanocomposite materials, antioxidants and colorants is within the said range, the amount of the said dispersant is 0.0-3.0 parts by weight, preferably 0.01-2.45 parts by weight.

The said dispersant is one or more dispersant(s) selected from silicone oils, paraffin oil, poly(ethylene oxide), poly(propylene oxide) or ethylene oxide-propylene oxide copolymer.

The material composition for producing nano-PET monolayer beer bottles with barrier property may also contain one or more resin(s) selected from polyester, polyolefin, phenoxy resin and the like. These resins are currently commercially available in the market, such as polyester grades MP100 sold by Eastman chemical under the trade name Tritan, polyolefin resin sold by Yanshan Branch, China Petrochemical Co. under the trade name PE-30A, and phenoxy resin sold by Shengquan Group Corporation under the trade name SQP-40AXM40.

In the present invention, the said material composition may also contain a number of additives which can improve or enhance the performance of the material composition. These additives are described as follows:

Glass fiber, carbon fiber and other reinforcing agent, the role of the said reinforcing agent is to improve the rigidity and top pressure intensity of beer bottles, they are, for example, conventional products currently commercially available on the market.

Conventional glass flakes, mica or talc flaky inorganic filler, their role is to improve the heat resistance and light-blocking performance of beer bottles, they are conventional products which are currently commercially available on the market.

Polyester-polyether elastomer impact modifiers, their role is to maintain and improve the impact strength of the beer bottle, which is, for example, the polyester-polyether elastomer sold by DSM Co., Holland under the trade name EF630.

Sodium benzoate, sodium salts or zinc salts of ethylene-methacrylic acid copolymer nucleating agent, their role is to increase the crystallization rate of PET molecule, and thus increase the crystallinity of beer bottles, to improve the heat-resistance temperature of the beer bottles, in favor of the smooth progress of the pasteurization process of beer bottles, which is, for example, product sold by DuPont Co., US under the trade name Surlyn.

Lubricants sodium salts or zinc salts of aliphatic amides or aliphatic acids with carbon atoms of 16-50, specifically such as erucic amide lubricant, for example, they are products sold by Hengchang Chemical Co., Ltd., Changsha City, Hunan Province.

Benzotriazole UV absorber, its role is to absorb ambient ultraviolet light through the wall of beer bottles, to reduce the beer oxidation caused by UV light, maintaining beer quality, which is, for example, the product sold by Xintai Chemical Technology Co., Ltd., Xi'an City.

Polysiloxane mold release agent, its role is to make the outer wall of the bottle is not stick and easy to release from the mold when beer bottles cooling release after the blow molding, for example, it's the product sold by Wuhan Modern Industrial Technology Institute under the trade name WH1500 epoxy polysiloxane resin.

Deoxidizer composed of butadiene oligomer or MXD6 (meta-xylylene adipamide)oxygen absorbent component and cobalt-containing metal compound catalyst, its role is to consume oxygen by reacting butadiene oligomer or MXD6 with dissolved oxygen in bottles' material under the catalysis of cobalt metal compound. Thus, to prevent the infiltration of oxygen from the air into the bottle wall, further into the beer, leading the bear to oxidative deterioration. It is, for example, the product sold by Mitsubishi Engineering-Plastics Co., Japan under the trade name 1022F.

In the present invention, those skilled in the art can determine the amount of these additives in the material composition of the present invention in a conventional manner according to the practical application.

Preferably, the material composition contains the following components in parts by weight:

| | |
|---|---|
| layered silicate PET nanocomposite material | 95.0-97.0; |
| antioxidant | 0.18-1.56; |
| colorant | 0.04-1.66; |
| dispersant | 0.01-2.45. |

The present invention also relates to the method for producing the nano-PET monolayer beer bottles with barrier property from the said material composition.

The nano-PET monolayer beer bottles with barrier property of the present invention are manufactured according to the existing producing method of single-layer PET bottle for beer. Specifically, according to the formulation of material composition for the production of nano-PET monolayer beer bottles with barrier property, layered silicate PET nanocomposite material is mixed with other components and then made into beer bottles by the injection-stretch-blow molding way.

The steps of the method are as follows:

A. Production of Beer Bottle Preforms

Drying the layered silicate PET nanocomposite pellets in a dehumidifying dryer at a temperature of 150-170° C. for 4-6 h, then uniformly mixing 93.0-99.8 parts by weight of the dried layered silicate PET nanocomposite pellets and 0.02-2.0 parts by weight of antioxidant, 0.0-2.0 parts by weight of colorant and 0.0-3.0 parts by weight of dispersant, and sending to the inlet of the injection molding machine, melt mixing and plasticizing by the screw in injection molding machine, the resulting fused material injecting into the mold and then injection molding, thereby obtaining the PET monolayer beer bottle preforms;

The nano-PET monolayer beer bottles with barrier property of the present invention also can be manufactured according to the following method: Adding the said colorant and the said dispersant in the preparation of the said layered silicate PET nanocomposite material, then drying the resulting mixture at a temperature of 150-170° C. for 4-6 h, subsequently adding the said antioxidant, mixing and then sending to the inlet of the injection molding machine, melt mixing and plasticizing by the screw in injection molding machine, the resulting fused material injecting into the mold and then injection molding, thereby obtaining the PET monolayer beer bottle preforms.

The water content of the said layered silicate PET nanocomposite pellets or the said mixture after drying is less than 50 ppm by the weight.

Due to the much higher cooling crystallization rate of melt of layered silicate PET nanocomposite material than that of the general PET resins, the melting state of nano-PET resin must be controlled more strictly. Preforms formed by injection molding, especially the injection gate of the preforms, must be rapidly cooled so that the nano-PET bottle preforms obtained will have low crystallinity, which meets the technical requirements for the stretch blow molding of PET bottles in the following process.

B. Production of Beer Bottles

Placing the PET monolayer beer bottle preforms produced in Step A on the PET bottle blowing machine, after heating, stretching, blow molding, cooling and mold unloading, obtaining the said nano-PET monolayer beer bottles with barrier property.

The prior preform blow molding method includes the cold blank method and hot blank method. For example, the preform's surface is heated to a temperature of 80-120° C., and then extended along the axial direction by a mechanical means like inserting the mandrel, then blowing 2-4 MPa high pressure air to extend transversely and blow molding. Alternatively, firstly the surface of the preform's mouth portion is heated to a temperature of the 80-120° C. and crystallized, and then blow molded in the mold at a temperature of 90-150° C.

Due to the high crystallization rate of nano-PET preforms adopted by the present invention, bottles may occur some adverse situations during molding, so that preheating and stretching speed of the preform, high and low pressure and process, temperature and cooling procedure of the mold need to be strictly controlled to make the nano-PET bottle produce smoothly and meet the performance requirements of beer bottles.

The thickness of the layered silicate nano-PET monolayer beer bottles is not necessary overall consistency, usually in the range of 0.2-1.0 mm.

According to the actual needs of the filling and production of gas pressure beverage and beer, the performances of the nano-PET monolayer beer bottles with barrier property are detected in the following manner.

A. Oxygen Permeation Rate

The oxygen permeation rate of the nano-PET monolayer beer bottles with barrier property of the present invention is measured as follows: According to ASTM F-1307 Standard, using a OX-TRAN 2/21 oxygen transmission rate system manufactured by MOCON Inc. US, the oxygen transmission rate of the nano-PET monolayer beer bottles with barrier property of the present invention is measured at a temperature of 23° C., relative humidity inside bottle of 100% and relative humidity outside bottle of 50%. The oxygen permeation rate of the nano-PET monolayer beer bottles with barrier property of the present invention can reach 0.015-0.043 cm³/bottle·day·0.21 atm. The oxygen permeation rate of the ordinary PET bottle is detected using the same way. It is very significantly higher than that of the nano-PET monolayer beer bottles of the present invention, reaching 0.051 cm³/bottle·day·0.21 atm.

The oxygen permeation rate of the wall of nano-PET monolayer beer bottles with barrier property of the present invention is measured as follows: After the disintegration of the bottle, the bottle is removed and flatten into thin slices. According to GB/T 1038-2000 Standard, using a N500-type oxygen transmission analyzer sold by Biaoji Packaging Equipment Co., Guangzhou, the oxygen transmission rate of the flatten thin slices is measured to be 1.1^{˜}3.0 cm³/m²·day·atm. Using the same way, that of the flatten thin slices of the ordinary PET bottle is measured to be 3.5 cm³/m²·day·atm which is very significantly higher than that of the nano-PET monolayer beer bottles with barrier property of the present invention.

B. Heat Resistance/Pressure Resistance

Into a nano-PET monolayer beer bottle with barrier property of the present invention, water at room temperature is poured. Then the bottle is immersed into water at 60° C., and then pressurized to 0.6 MPa to maintain for more than 30 min. Detect changes in the shape of the bottle. The result shows that the nano-PET monolayer beer bottle with barrier property of the present invention has no explosion and no significant changes in appearance. The ordinary PET bottle is detected using the same way. The result shows that the ordinary PET bottle has no explosion while there is significant swell in appearance. It means that the nano-PET monolayer beer bottles with barrier property of the present invention have good heat resistance/pressure resistance.

### Beneficial Effects

The plastic beer bottles of the present invention are PET monolayer beer bottles made from layered silicate nanomaterial modified nano-PET resin. The PET monolayer beer bottles have good barrier property, low oxygen permeation rate and good light-blocking performance, which can extend the shelf life of PET bottled beer; They have good heat resistance to meet the requirements of filling and pasteurization (at 60° C. 30 min) of beer bottles; They have light weight and are non-explosive to meet the transportation, storage and consumption requirements. The beer bottles contain a variety of ingredients which are all in line with national standards for food contact packaging materials, and healthy and safety. The manufacturing process of the present invention is simple, feasible, and just needs standard production equipment and less investment. The nano-PET monolayer beer bottles with barrier property of the present invention are disposable beer packaging containers and can be blended and recycled with recycled ordinary PET bottle material in any proportion. When used in the downstream, such as melt spinning, sheet extrusion molding or the like, the recovered material have no adverse effect on the process. Products and manufacturing processes are environmentally friendly and have strong competitiveness.

### EXAMPLES

It will be able to better understand the present invention by the following examples.

### Example 1

### Production of Natural Nano-PET Monolayer Beer Bottles of the Present Invention with Barrier Property

The implementation steps of this example are as follows:

According to the method described in Chinese Patent No. ZL02123499.X, layered silicate PET nanocomposite pellets were prepared. The said layered silicate PET nanocomposite pellets were composed of 96 parts by weight of PET, 0.3 parts by weight of layered silicate montmorillonite, 0.1 parts by weight of intercalation agent dodecylamine and 10 parts by weight of compatilizer ethylene-methacrylic acid copolymer sodium salt. Their intrinsic viscosity was measured to be 0.60 dl/g using the method described in the description.

The layered silicate PET nanocomposite pellets were dried in a dehumidifying dryer manufactured by Shini Electric Heating Machine Co. Taiwan at a temperature of 162° C. for 4.5 h. Then 93.0 parts by weight of the dried layered silicate PET nanocomposite pellets, 0.02 parts by weight of antioxidant tetra-[β-(3,5-di-tert-butyl-4-hydroxyphenyl)propionate]pentaerythritol ester and 0.5 parts by weight of dispersant silicone oil were mixed well and sent to the inlet of the injection molding machine produced by Husky Co., Canada, melt mixed and plasticized by the screw in injection molding machine. The resulting fused material was injected into the mold and then injection molded, the natural PET monolayer beer bottle preform thus obtained present transparent pale khaki color.

Subsequently, the natural PET monolayer beer bottle preform was molded by a rotary heating blowing molding machine produced by Sidel Co., France to obtain the natural nano-PET monolayer beer bottles with barrier property of the present invention. The performance of the nano-PET monolayer beer bottles with barrier property produced in this example was tested. The results are listed in Table 1.

### Example 2

### Production of the Natural Nano-PET Monolayer Beer Bottles with Barrier Property of the Present Invention

The implementation steps of this example are as follows:

According to the method described in Chinese Patent No. ZL02123499.X, layered silicate PET nanocomposite pellets were prepared. The said layered silicate PET nanocomposite pellets were composed of 85 parts by weight of PET, 1.0 parts by weight of layered silicate hectorite, 2.0 parts by weight of intercalation agent hexadecylamine and 1.0 parts by weight of compatilizer ethylene-methacrylic acid copolymer zinc salt. Their intrinsic viscosity was measured to be 0.77 dl/g using the method described in the description.

The layered silicate PET nanocomposite pellets were dried in a dehumidifying dryer manufactured by Shini Electric Heating Machine Co. Taiwan at a temperature of 154° C. for 5.6 h. Then 98.0 parts by weight of the dried layered silicate PET nanocomposite pellets, 1.8 parts by weight of antioxidant n-octadecyl β-(3,5-di-tert-butyl-4-hydroxyphenyl)propionate, 1.6 parts by weight of colorant Pigment Green 36 and 0.5 parts by weight of dispersant paraffin oil were mixed well and sent to the inlet of the injection molding machine produced by Husky Co., Canada, melt mixed and plasticized by the screw in injection molding machine. The resulting fused material was injected into the mold and then injection molded, thereby obtaining a PET monolayer beer bottle preform.

Subsequently, the said PET monolayer beer bottle preform was molded by a rotary heating blowing molding machine produced by Sidel Co., France to obtain the natural nano-PET monolayer beer bottles with barrier property of the present invention. The performance of the nano-PET monolayer beer bottles with barrier property produced in this example was tested. The results are listed in Table 1.

### Example 3

### Production of the Yellow Nano-PET Monolayer Beer Bottles with Barrier Property of the Present Invention

The implementation steps of this example are as follows:

According to the method described in Chinese Patent No. ZL02123499.X, layered silicate PET nanocomposite pellets were prepared. The said layered silicate PET nanocomposite pellets were composed of 88 parts by weight of PET, 6.0 parts by weight of layered silicate Kaolin, 4.0 parts by weight of intercalation agent hexylenediamine and 6.0 parts by weight of compatilizer poly(ethylene oxide). Their intrinsic viscosity was measured to be 0.74 dl/g using the method described in the description.

The layered silicate PET nanocomposite pellets were dried in a dehumidifying dryer manufactured by Shini Electric Heating Machine Co. Taiwan at a temperature of 168° C. for 4.2 h. Then 96.2 parts by weight of the dried layered silicate PET nanocomposite pellets, 1.4 parts by weight of antioxidant dilauryl thiodipropionate, 1.2 parts by weight of colorant Pigment Yellow 68 and 2.0 parts by weight of dispersant poly(ethylene oxide) were mixed well and sent to the inlet of the injection molding machine produced by Husky Co., Canada, melt mixed and plasticized by the screw in injection molding machine. The resulting fused material was injected into the mold and then injection molded, thereby obtaining a PET monolayer beer bottle preform.

Subsequently, the said PET monolayer beer bottle preform was molded by a rotary heating blowing molding machine produced by Sidel Co., France to obtain the yellow nano-PET monolayer beer bottles with barrier property of the present invention. The performance of the nano-PET monolayer beer bottles with barrier property produced in this example was tested. The results are listed in Table 1.

### Example 4

### Production of the Natural Nano-PET Monolayer Beer Bottles with Barrier Property of the Present Invention

The implementation steps of this example are as follows:

According to the method described in Chinese Patent No. ZL02123499.X, layered silicate PET nanocomposite pellets were prepared. The said layered silicate PET nanocomposite pellets were composed of 80 parts by weight of PET, 8 parts by weight of layered silicate magnesium lithium silicate, 7 parts by weight of intercalation agent lauric acid amine and 8 parts by weight of compatilizer poly(propylene oxide). Their intrinsic viscosity was measured to be 0.68 dl/g using the method described in the description.

The layered silicate PET nanocomposite pellets were dried in a dehumidifying dryer manufactured by Shini Electric Heating Machine Co. Taiwan at a temperature of 162° C. for 4.4 h. Then 94.4 parts by weight of the dried layered silicate PET nanocomposite pellets, 0.8 parts by weight of antioxidant dimyristyl thiodipropionate and 0.6 parts by weight of colorant Direct Blue 199 were mixed well and sent to the inlet of the injection molding machine produced by Husky Co., Canada, melt mixed and plasticized by the screw in injection molding machine. The resulting fused material was injected into the mold and then injection molded, thereby obtaining a PET monolayer beer bottle preform.

Subsequently, the said PET monolayer beer bottle preform was molded by a rotary heating blowing molding machine produced by Sidel Co., France to obtain the natural nano-PET monolayer beer bottles with barrier property of the present invention. The performance of the nano-PET monolayer beer bottles with barrier property produced in this example was tested. The results are listed in Table 1.

### Example 5

### Production of the Natural Nano-PET Monolayer Beer Bottles with Barrier Property of the Present Invention

The implementation steps of this example are as follows:

According to the method described in Chinese Patent No. ZL02123499.X, layered silicate PET nanocomposite pellets were prepared. The said layered silicate PET nanocomposite pellets were composed of 82 parts by weight of PET, 9 parts by weight of layered silicate montmorillonite, 3 parts by weight of intercalation agent triethanolamine and 6 parts by weight of compatilizer poly(propylene oxide). Their intrinsic viscosity was measured to be 0.72 dl/g using the method described in the description.

The layered silicate PET nanocomposite pellets were dried in a dehumidifying dryer manufactured by Shini Electric Heating Machine Co. Taiwan at a temperature of 152° C. for 5.6 h. Then 95.6 parts by weight of the dried layered silicate PET nanocomposite pellets, 1.2 parts by weight of antioxidant tri-octanol phosphite and 1.0 parts by weight of colorant Solvent Blue 97 were mixed well and sent to the inlet of the injection molding machine produced by Husky Co., Canada, melt mixed and plasticized by the screw in injection molding machine. The resulting fused material was injected into the mold and then injection molded, thereby obtaining a PET monolayer beer bottle preform.

Subsequently, the said PET monolayer beer bottle preform was molded by a rotary heating blowing molding machine produced by Sidel Co., France to obtain the natural nano-PET monolayer beer bottles with barrier property of the present invention. The performance of the nano-PET monolayer beer bottles with barrier property produced in this example was tested. The results are listed in Table 1.

### Example 6

### Production of the Natural Nano-PET Monolayer Beer Bottles with Barrier Property of the Present Invention

The implementation steps of this example are as follows:

According to the method described in Chinese Patent No. ZL02123499.X, layered silicate PET nanocomposite pellets were prepared. The said layered silicate PET nanocomposite pellets were composed of 96 parts by weight of PET, 3 parts by weight of layered silicate Kaolin, 9 parts by weight of intercalation agent dodecyl trimethyl ammonium bromide and 5 parts by weight of compatilizer bisphenol A epoxy resin. Their intrinsic viscosity was measured to be 0.55 dl/g using the method described in the description.

The layered silicate PET nanocomposite pellets were dried in a dehumidifying dryer manufactured by Shini Electric Heating Machine Co. Taiwan at a temperature of 150° C. for 6.0 h. Then 98.2 parts by weight of the dried layered silicate PET nanocomposite pellets, 1.8 parts by weight of antioxidant tri-decanol phosphite, 1.7 parts by weight of colorant Solvent Red 179 and 2.2 parts by weight of dispersant paraffin oil were mixed well and sent to the inlet of the injection molding machine produced by Husky Co., Canada, melt mixed and plasticized by the screw in injection molding machine. The resulting fused material was injected into the mold and then injection molded, thereby obtaining a PET monolayer beer bottle preform.

Subsequently, the said PET monolayer beer bottle preform was molded by a rotary heating blowing molding machine produced by Sidel Co., France to obtain the natural nano-PET monolayer beer bottles with barrier property of the present invention. The performance of the nano-PET monolayer beer bottles with barrier property produced in this example was tested. The results are listed in Table 1.

### Example 7

### Production of the Natural Nano-PET Monolayer Beer Bottles with Barrier Property of the Present Invention

The implementation steps of this example are as follows:

According to the method described in Chinese Patent No. ZL02123499.X, layered silicate PET nanocomposite pellets were prepared. The said layered silicate PET nanocomposite pellets were composed of 98 parts by weight of PET, 10 parts by weight of layered silicate montmorillonite, 5 parts by weight of intercalation agent cetyl trimethyl ammonium bromide and 9 parts by weight of compatilizer ethylene-methacrylic acid copolymer sodium salt. Their intrinsic viscosity was measured to be 0.78 dl/g using the method described in the description.

The layered silicate PET nanocomposite pellets were dried in a dehumidifying dryer manufactured by Shini Electric Heating Machine Co. Taiwan at a temperature of 170° C. for 4.0 h. Then 99.8 parts by weight of the dried layered silicate PET nanocomposite pellets, 2.0 parts by weight of antioxidant N,N′-bis[3-(3,5-di-tert-butyl-4-hydroxyphenyl)propionyl]hexamethylene diamine, 2.0 parts by weight of colorant CAS No. 4174-09-8 and 3.0 parts by weight of dispersant silicone oil were mixed well and sent to the inlet of the injection molding machine produced by Husky Co., Canada, melt mixed and plasticized by the screw in injection molding machine. The resulting fused material was injected into the mold and then injection molded, thereby obtaining a PET monolayer beer bottle preform.

Subsequently, the said PET monolayer beer bottle preform was molded by a rotary heating blowing molding machine produced by Sidel Co., France to obtain the natural nano-PET monolayer beer bottles with barrier property of the present invention. The performance of the nano-PET monolayer beer bottles with barrier property produced in this example was tested. The results are listed in Table 1.

### Example 8

### Production of the Natural Nano-PET Monolayer Beer Bottles with Barrier Property of the Present Invention

The implementation steps of this example are as follows:

According to the method described in Chinese Patent No. ZL02123499.X, layered silicate PET nanocomposite pellets were prepared. The said layered silicate PET nanocomposite pellets were composed of 90 parts by weight of PET, 5 parts by weight of layered silicate kaolin, 6 parts by weight of intercalation agent octadecyl trimethyl ammonium bromide and 3 parts by weight of compatilizer ethylene-methacrylic acid copolymer sodium salt. Their intrinsic viscosity was measured to be 0.65 dl/g using the method described in the description.

The layered silicate PET nanocomposite pellets were dried in a dehumidifying dryer manufactured by Shini Electric Heating Machine Co. Taiwan at a temperature of 158° C. for 5.2 h. Then 94.5 parts by weight of the dried layered silicate PET nanocomposite pellets, 0.8 parts by weight of antioxidant distearyl thiodipropionate, 0.7 parts by weight of colorant Solvent Yellow 114 and 1.0 parts by weight of dispersant paraffin oil were mixed well and sent to the inlet of the injection molding machine produced by Husky Co., Canada, melt mixed and plasticized by the screw in injection molding machine. The resulting fused material was injected into the mold and then injection molded, thereby obtaining a PET monolayer beer bottle preform.

Subsequently, the said PET monolayer beer bottle preform was molded by a rotary heating blowing molding machine produced by Sidel Co., France to obtain the natural nano-PET monolayer beer bottles with barrier property of the present invention. The performance of the nano-PET monolayer beer bottles with barrier property produced in this example was tested. The results are listed in Table 1.

### Example 9

### Production of the Natural Nano-PET Monolayer Beer Bottles with Barrier Property of the Present Invention

The implementation steps of this example are as follows:

According to the method described in Chinese Patent No. ZL02123499.X, layered silicate PET nanocomposite pellets were prepared. The said layered silicate PET nanocomposite pellets were composed of 94 parts by weight of PET, 7 parts by weight of layered silicate montmorillonite, 8 parts by weight of intercalation agent lauric acid amine and 7 parts by weight of compatilizer ethylene-methacrylic acid copolymer zinc salt. Their intrinsic viscosity was measured to be 0.70 dl/g using the method described in the description.

The layered silicate PET nanocomposite pellets were dried in a dehumidifying dryer manufactured by Shini Electric Heating Machine Co. Taiwan at a temperature of 160° C. for 5.0 h. Then 93.6 parts by weight of the dried layered silicate PET nanocomposite pellets, 0.6 parts by weight of antioxidant bis(2,4-di-t-butylphenyl)pentaerythritol diphosphite, 0.4 parts by weight of colorant Pigment Red 178 and 0.8 parts by weight of dispersant poly(propylene oxide) were mixed well and sent to the inlet of the injection molding machine produced by Husky Co., Canada, melt mixed and plasticized by the screw in injection molding machine. The resulting fused material was injected into the mold and then injection molded, thereby obtaining a PET monolayer beer bottle preform.

Subsequently, the said PET monolayer beer bottle preform was molded by a rotary heating blowing molding machine produced by Sidel Co., France to obtain the natural nano-PET monolayer beer bottles with barrier property of the present invention. The performance of the nano-PET monolayer beer bottles with barrier property produced in this example was tested. The results are listed in Table 1.

### Example 10

### Production of the Natural Nano-PET Monolayer Beer Bottles with Barrier Property of the Present Invention

The implementation steps of this example are as follows:

According to the method described in Chinese Patent No. ZL02123499.X, layered silicate PET nanocomposite pellets were prepared. The said layered silicate PET nanocomposite pellets were composed of 99.7 parts by weight of PET, 4 parts by weight of layered silicate hectorite, 6 parts by weight of intercalation agent hexadecylamine and 4 parts by weight of compatilizer polyethylene oxide. Their intrinsic viscosity was measured to be 0.76 dl/g using the method described in the description.

The layered silicate PET nanocomposite pellets were dried in a dehumidifying dryer manufactured by Shini Electric Heating Machine Co. Taiwan at a temperature of 165° C. for 4.0 h. Then 95.2 parts by weight of the dried layered silicate PET nanocomposite pellets, 1.1 parts by weight of antioxidant tetrakis(2,4-di-t-butylphenyl)-4,4′-biphenyl biphosphite, 0.9 parts by weight of colorant Pigment Yellow 74 and 1.8 parts by weight of dispersant ethylene oxide-propylene oxide copolymer were mixed well and sent to the inlet of the injection molding machine produced by Husky Co., Canada, melt mixed and plasticized by the screw in injection molding machine. The resulting fused material was injected into the mold and then injection molded, thereby obtaining a PET monolayer beer bottle preform.

Subsequently, the said PET monolayer beer bottle preform was molded by a rotary heating blowing molding machine produced by Sidel Co., France to obtain the natural nano-PET monolayer beer bottles with barrier property of the present invention. The performance of the nano-PET monolayer beer bottles with barrier property produced in this example was tested. The results are listed in Table 1.

### Example 11

### Production of the Natural Nano-PET Monolayer Beer Bottles with Barrier Property of the Present Invention

The implementation steps of this example are as follows:

According to the method described in Chinese Patent No. ZL02123499.X, layered silicate PET nanocomposite pellets were prepared. The said layered silicate PET nanocomposite pellets were composed of 82 parts by weight of PET, 2 parts by weight of layered silicate montmorillonite, 1 parts by weight of intercalation agent dodecylamine and 2 parts by weight of compatilizer ethylene oxide-propylene oxide copolymer. Their intrinsic viscosity was measured to be 0.58 dl/g using the method described in the description.

The layered silicate PET nanocomposite pellets were dried in a dehumidifying dryer manufactured by Shini Electric Heating Machine Co. Taiwan at a temperature of 152° C. for 5.7 h. Then 97.4 parts by weight of the dried layered silicate PET nanocomposite pellets, 1.6 parts by weight of antioxidant tetra-[β-(3,5-di-tert-butyl-4-hydroxyphenyl)propionate]pentaerythritol ester, 1.2 parts by weight of colorant Solvent Blue 104 and 2.2 parts by weight of dispersant silicone oil were mixed well and sent to the inlet of the injection molding machine produced by Husky Co., Canada, melt mixed and plasticized by the screw in injection molding machine. The resulting fused material was injected into the mold and then injection molded, thereby obtaining a PET monolayer beer bottle preform.

Subsequently, the said PET monolayer beer bottle preform was molded by a rotary heating blowing molding machine produced by Sidel Co., France to obtain the natural nano-PET monolayer beer bottles with barrier property of the present invention. The performance of the nano-PET monolayer beer bottles with barrier property produced in this example was tested. The results are listed in Table 1.

### Example 12

### Production of the Natural Nano-PET Monolayer Beer Bottles with Barrier Property of the Present Invention

The implementation steps of this example are as follows:

According to the method described in Chinese Patent No. ZL02123499.X, layered silicate PET nanocomposite pellets were prepared. The said layered silicate PET nanocomposite pellets were composed of 96 parts by weight of PET, 0.6 parts by weight of layered silicate magnesium lithium silicate, 10 parts by weight of intercalation agent octadecyl trimethyl ammonium bromide and 0.3 parts by weight of compatilizer ethylene-methacrylic acid copolymer zinc salt. Their intrinsic viscosity was measured to be 0.78 dl/g using the method described in the description.

The layered silicate PET nanocomposite pellets were dried in a dehumidifying dryer manufactured by Shini Electric Heating Machine Co. Taiwan at a temperature of 158° C. for 5.3 h. Then 99.4 parts by weight of the dried layered silicate PET nanocomposite pellets, 1.9 parts by weight of antioxidant dimyristyl thiodipropionate, 1.8 parts by weight of colorant Solvent Violet 13 and 2.8 parts by weight of dispersant silicone oil were mixed well and sent to the inlet of the injection molding machine produced by Husky Co., Canada, melt mixed and plasticized by the screw in injection molding machine. The resulting fused material was injected into the mold and then injection molded, thereby obtaining a PET monolayer beer bottle preform.

Subsequently, the said PET monolayer beer bottle preform was molded by a rotary heating blowing molding machine produced by Sidel Co., France to obtain the natural nano-PET monolayer beer bottles with barrier property of the present invention. The performance of the nano-PET monolayer beer bottles with barrier property produced in this example was tested. The results are listed in Table 1.

### Comparative Example 1

### Ordinary PET Bottle

Bottle-grade PET pellets sold by SINOPEC (intrinsic viscosity of 0.87) were dried in a dehumidifying dryer manufactured by Shini Electric Heating Machine Co. Taiwan at a temperature of 170° C. for 4 h, and then molded into PET nanocomposite bottle preforms with the weight of 28 g by an injection molding machine produced by Husky Co., Canada. The size of the bottle preforms is the same as that of the bottle preforms of the Example 1, and present colorless and transparent.

The PET bottle preforms were molded by the rotary heating blowing molding machine produced by Sidel Co., France to obtain PET monolayer ipomoea bottle with the internal capacity of 500 ml. The size of the ordinary PET bottles is the same as that of the natural bottles of the Example 1 and present colorless and transparent. The size of the bottles is 235 mm of height and 66 mm of external diameter. The test results of performance of the ordinary PET monolayer beer bottles of the comparative example are listed in Table 1.

TABLE 1
The Test Results of Performance of the PET Monolayer Beer
Bottles of the Example 1-12 and the Comparative Example

| | Oxygen Permeation Rate | Oxygen Permeation | Heat Resistance/ |
|---|---|---|---|
| Example | of Bottles | Rate of Bottle Slices | Pressure Resistance |
| NO. | (cm³/bottle · day · 0.21 atm) | (cm³/m² · day · atm) | (60° C./0.6 MPa/30 min) |
| 1 | 0.043 | 3.0 | no explosion, no |
| | | | significant change in |
| | | | appearance |
| 2 | 0.020 | 1.4 | no explosion, no |
| | | | significant change in |
| | | | appearance |
| 3 | 0.025 | 1.7 | no explosion, no |
| | | | significant change in |
| | | | appearance |
| 4 | 0.022 | 1.5 | no explosion, no |
| | | | significant change in |
| | | | appearance |
| 5 | 0.017 | 1.2 | no explosion, no |
| | | | significant change in |
| | | | appearance |
| 6 | 0.037 | 2.5 | no explosion, no |
| | | | significant change in |
| | | | appearance |
| 7 | 0.019 | 1.3 | no explosion, no |
| | | | significant change in |
| | | | appearance |
| 8 | 0.035 | 2.4 | no explosion, no |
| | | | significant change in |
| | | | appearance |
| 9 | 0.027 | 1.9 | no explosion, no |
| | | | significant change in |
| | | | appearance |
| 10 | 0.015 | 1.0 | no explosion, no |
| | | | significant change in |
| | | | appearance |
| 11 | 0.030 | 2.0 | no explosion, no |
| | | | significant change in |
| | | | appearance |
| 12 | 0.038 | 2.6 | no explosion, no |
| | | | significant change in |
| | | | appearance |
| Comparative | 0.051 | 3.5 | no explosion, |
| Example 1 | | | significant swell in |
| | | | appearance |

The results in Table 1 clearly shows that the layered silicate nano-PET monolayer beer bottles of the present invention have better oxygen barrier property than that of the pure PET bottles with the same specifications, and feature no explosion and excellent heat resistance, which improves the integrated performance of PET beer bottles and has great application significance.

What is claimed is:

1. A material composition for producing nano-PET monolayer beer bottles with barrier property, characterized in that the material composition contains the following components in parts by weight:

| | |
|---|---|
| layered silicate PET nanocomposite material | 93.0-99.8; |
| antioxidant | 0.02-2.0; |
| colorant | 0.0-2.0; |
| dispersant | 0.0-3.0. |

2. The material composition according to claim 1, characterized in that the material composition contains the following components in parts by weight:

| | |
|---|---|
| the layered silicate PET nanocomposite material | 95.0-97.0; |
| the antioxidant | 0.18-1.56; |
| the colorant | 0.04-1.66; |
| the dispersant | 0.01-2.45. |

3. The material composition according to claim 1 or claim 2, characterized in that the layered silicate PET nanocomposite material is composed of 80-99.7 parts by weight of polyethylene terephthalate, 0.3-10 parts by weight of layered silicate, 0.1-10 parts by weight of intercalation agent and 0.3-10 parts by weight of compatilizer;
said layered silicate is selected from the group consisting of montmorillonite, hectorite, kaolin natural silicates and magnesium lithium silicate synthetic laminated silicate;
said intercalation agent is selected from the group consisting of dodecylamine, hexadecylamine, hexylenediamine, lauric acid amine, triethanolamine, dodecyl trimethyl ammonium bromide, cetyl trimethyl ammonium bromide, octadecyl trimethyl ammonium bromide and octadecyl dimethyl benzyl ammonium bromide;
said compatilizer is selected from the group consisting of ethylene-methacrylic acid copolymer sodium salt, ethylene-methacrylic acid copolymer zinc salt, polyethylene oxide, polypropylene oxide, ethylene oxide-propylene oxide copolymer and bisphenol A epoxy resin.

4. The material composition according to claim 1 or claim 2, characterized in that the antioxidant is one or more antioxidant(s) selected from the group consisting of hindered phenolic antioxidants, thioester antioxidants and phosphite antioxidants;
said hindered phenolic antioxidant is selected from the group consisting of tetra-[β-(3,5-di-tert-butyl-4-hydroxyphenyl)propionate]pentaerythritol ester, n-octadecyl β-(3,5-di-tert-butyl-4-hydroxyphenyl)propionate, N,N′-bis[3-(3,5-di-tert-butyl-4-hydroxyphenyl)propionyl]hexamethylene diamine, Triethylene glycol-bis[β-(3-tert-butyl-4-hydroxy-5-methylphenyl)propionate], N,N′-bis[β-(3,5-di-tert-butyl-4-hydroxyphenyl)propionyl]hydrazine and 4,4′-thiobis(6-tert-butyl-3-methylphenol);
said thioester antioxidant is selected from the group consisting of dilauryl thiodipropionate, dimyristyl thiodipropionate and distearyl thiodipropionate;
said phosphite antioxidant is selected from the group consisting of tri-octanol phosphite, tri-decanol phosphite, tris(dodecanol) phosphite, tris(hexadecanol) phosphite, triphenyl phosphite, tris(2,4-di-t-butylphenyl)phosphite, tetrakis(2,4-di-tert-octaalkoxy)-4,4′-biphenyl diphosphite, bis(2,4-di-t-butylphenyl)pentaerythritol diphosphite, (2,4,6-tri-tert-butyl-phenyl-2-butyl-2-ethyl)-1,3-propanediol phosphite, bis(2,4-di-p-isopropylphenyl)pentaerythritol bisphosphite, 2,2′-ethylenebis(4,6-di-tert-butyl-phenyl)fluorophosphite, tetrakis(2,4-di-t-butylphenyl)-4,4′-biphenyl biphosphite and spiro-glycol bis[2,2′-methylenebis (4,6-di-tert-butyl phenyl)]phosphite.

5. The material composition according to claim 1, characterized in that the colorant is a pigment or a dye;
wherein the pigment is selected from the group consisting of Pigment Green 36, Pigment Yellow 68, Direct Blue 199, Pigment Yellow 147, Pigment Green 36, Pigment Orange 61, Pigment Red 178, Pigment Yellow 74, Pigment Yellow 65, Pigment Yellow 151 and transparent yellow iron oxide;
said dye is selected from the group consisting of Solvent Blue 97, Solvent Violet 36, Solvent Red 179, CAS No. 4174-09-8, CAS No. 247089-62-9, CAS No. 75641-02-0, Solvent Yellow 160:1, Disperse Yellow 241, Solvent Yellow 114, Solvent Orange 60, Solvent Red 111, Solvent Red 135, Solvent Blue 104, Solvent Green 3, Solvent Violet 13 and Solvent Yellow 93.

6. The material composition according to claim 1, characterized in that the dispersant is one or more dispersant(s) selected from the group consisting of silicone oil, paraffin oil, poly(ethylene oxide), poly(propylene oxide) and ethylene oxide-propylene oxide copolymer.

7. The material composition according to claim 1, characterized in that the material comprises one or more additive(s) selected from the group consisting of (i) polyester, polyolefin or phenoxy resin mixed modifier; (ii) glass fiber or carbon fiber reinforcement; (iii) glass flakes, talc or mica flaky inorganic filler; (iv) polyester-polyether elastomer impact modifiers; (v) sodium benzoate or sodium salts or zinc salts of ethylene-methacrylic acid copolymer nucleating agent; (vi) lubricants sodium salts or zinc salts of aliphatic amides or aliphatic acids with carbon atoms of 16-50; (vii) benzotriazole UV absorber; (viii) polysiloxane mold release agent and (ix) deoxidizer composed of butadiene oligomer or MXD6 oxygen absorbent component and cobalt-containing metal compound catalyst.

8. A method for producing the nano-PET monolayer beer bottles with barrier property from the material composition according to claim 1, characterized in that the steps of the method are as follows:
i) production of beer bottle preforms
drying the layered silicate PET nanocomposite pellets in a dehumidifying dryer at a temperature of 150-170° C. for 4-6 h, then uniformly mixing 93.0-99.8 parts by weight of the dried layered silicate PET nanocomposite pellets, 0.02-2.0 parts by weight of antioxidant, 0.0-2.0 parts by weight of colorant and 0.0-3.0 parts by weight of dispersant, and sending to the inlet of the injection molding machine, melt mixing and plasticizing by the screw in injection molding machine, the resulting fused material injecting into the mold and then injection molding, thereby obtaining the PET monolayer beer bottle preforms;
ii) production of beer bottles
placing the PET monolayer beer bottle preforms on the PET bottle blowing machine, after heating, stretching, blow molding, cooling and mold unloading, obtaining the said nano-PET monolayer beer bottles with barrier property.

9. A method for producing the nano-PET monolayer beer bottles with barrier property from the material composition according to claim 1, characterized in that the steps of the method are as follows:
adding the colorant and the dispersant in the preparation of the layered silicate PET nanocomposite material, then drying the resulting mixture at a temperature of 150-170° C. for 4-6 h, subsequently adding the antioxidant, mixing and then sending to the inlet of the injection molding machine, melt mixing and plasticizing by the screw in injection molding machine, the resulting fused material injecting into the mold and then injection molding, thereby obtaining the PET monolayer beer bottle preforms.

10. The production method according to claim 8 or 9, characterized in that the water content of the layered silicate PET nanocomposite pellets or the mixture after drying is less than 50 ppm by the weight.
